(19) United States
(12) Patent Application Publication
(10) Pub. No.: US 2022/0275750 A1
(43) Pub. Date: Sep. 1, 2022

(54) Gas Compressor

(71) Applicant: BMTS Technology GmbH & Co. KG, Stuttgart (DE)

(72) Inventors: Sebastian Beyerlein, Neuhausen auf den Fildern (DE); Rüdiger Kleinschmidt, Besigheim (DE); Steffen Schmitt, Ditzingen (DE); Oliver Kuhne, Stuttgart (DE); Philipp Blasch, Stuttgart (DE)

(21) Appl. No.: 17/679,253

(22) Filed: Feb. 24, 2022

(30) Foreign Application Priority Data
Feb. 26, 2021 (EP) 21 159 592.1

(51) Int. Cl. F02B 39/10; F02B 33/40

(52) U.S. Cl. CPC F02B 39/10; F02B 33/40

(57) ABSTRACT

The invention relates to a gas compressor 10, in particular a turbocharger, having a rotatably mounted compressor wheel which is arranged at least partially in a compressor housing, the compressor housing having a gas routing area, for guiding a gas stream compressed by means of the compressor wheel, wherein an electric motor is provided, which has a motor rotor and a motor stator and which is mounted at least sectionally in a mounting area of a motor housing. In order to ensure permanently reliable operation in such a gas compressor 10 in a simple manner, it is provided in accordance with the invention that a gas pressure generator is provided, which is connected to the mounting area of the motor housing (20) in an air-conveying manner via at least one gas pressure line (70).

### BACKGROUND OF THE DISCLOSURE

### Field of the Disclosure

The invention relates to a gas compressor, in particular a turbocharger, having a rotatably mounted compressor wheel, which is at least partially disposed in a compressor housing, the compressor housing having a gas routing area, for routing a gas stream compressed by means of the compressor wheel, wherein an electric motor is provided, which has a motor rotor and a motor stator and which is mounted at least sectionally in a mounting area of a motor housing.

Gas compressors in terms of the invention can be, for instance, turbochargers, in particular exhaust gas turbochargers, charging units, for instance for fuel cells, or other compressors, which can be used to compress a gas, preferably air.

### Description of the Prior Art

U.S. Pat. No. 8,157,544 B2 discloses an exhaust gas turbocharger, which bears a compressor wheel and a turbine wheel on a shaft. An electric motor is assigned to the shaft in the area of the compressor wheel. The electric motor can be used to support the drive of the shaft. The electric motor has a motor housing, in which the motor stator is installed. The motor stator has an iron core onto which coils are wound. The iron core and the coils are embedded in a casting compound. The permanent magnets of the motor rotor of the electric motor are mounted on the shaft. The motor housing has the form of a cartridge, which can be inserted into a bearing housing, in which the shaft is supported by means of hydrodynamic plain bearings. During operation, the compressor wheel draws in air along the axis of rotation of the shaft through a gas feed. The compressor wheel compresses the air, which is then transferred radially to the axis of rotation into a diffuser. The diffuser leads to a spiral duct. The air is further compressed in this spiral duct. Downstream of the spiral duct, the compressed air can be fed to an internal combustion engine. A compressor housing, in which the compressor wheel is located, forms the diffuser and the spiral duct. The electric motor can be used to optimize the response behavior of the turbocharger. A seal is provided in the area between the motor housing and the bearing housing. It shall prevent the lubricant needed to operate the hydrodynamic plain bearings from entering the area of the electric motor.

Lubricant leakage occurs in certain operating ranges of such electrically driven, hydrodynamic or roller-bearing supported gas compressors. On the compressor side, the lubricant is conveyed via the seal and the side chamber of the compressor wheel into the compressor discharge area. There, the lubricant contaminates the high-pressure compressor exhaust air. This happens in particular at low rotor speeds, because at low speeds the compressor does not generate a sufficiently high backpressure in the side chamber of the compressor wheel. In the case of an electrically supported gas compressor, the bearing lubricant can also enter the electric motor. If it is not removed, it can build up there, contaminating the components and, in the worst case, attacking the materials in that area. In contrast to the sealing point on the compressor side, which only shows leakage in the low-speed range, on the motor side leakage can occur in the entire operating range. For reasons inherent in the system, no pressure is built up here to counteract the leakage.

### SUMMARY OF THE DISCLOSURE

The invention addresses the problem of providing an electrically supported the gas compressor of the type mentioned above, which permits reliable operation in a simple manner.

This problem is solved by providing a gas pressure generator, which is connected to the mounting area of the motor housing via at least one gas pressure line in an air-conveying manner.

According to the invention, the gas pressure generator can be used to build up pressure in the mounting area of the motor housing via the gas pressure line. In particular, this allows an overpressure to be generated in the mounting area, which prevents contaminants, especially lubricant, from entering the mounting area. In this way, contamination in the mounting area and, accordingly, contamination of the motor rotor and/or motor stator is reliably, at least significantly, reduced. In this way, the operational reliability of the electric motor-assisted gas compressor is ensured in a simple manner.

According to a preferred variant of the invention provision can be made for the gas pressure generator to comprise the compressor wheel, and for the gas pressure line to be connected to the gas routing area formed by the compressor housing in a gas-conveying manner or to a gas routing area disposed downstream of the compressor housing. In this way, the pressure build-up generated by the compressor wheel is used to protect the mounting area of the motor housing from contamination. This also results in a particularly simple and cost-effective design.

A conceivable invention variant is such that the electric motor and its motor rotor are coupled indirectly or directly to a shaft, that the shaft has at least one bearing section for rotatably mounting the shaft, preferably in a bearing housing, that a sealing section, preferably comprising a seal, is arranged in the axial direction of the shaft between the bearing section and the motor rotor, and that the mounting area of the motor housing, which is connected to the gas pressure line in an air-conveying manner, and/or that the compressor wheel is arranged in the axial direction of the shaft on the side of the sealing section facing away from the bearing section.

The gas pressure line, as described above, is used to generate an overpressure in the mounting area relative to the area located on the side of the seal facing away from the mounting area. This prevents leaked fluids from entering the motor housing via the seal.

If both the mounting area of the motor housing and the compressor wheel are disposed on the side of the seal opposite from the bearing point, not only contamination of the electric motor but also contamination of the compressor wheel or the pressure area in the compressor housing is prevented. In particular, lubricants or other contaminants, for instance, which occur in the area of the side of the seal facing the bearing point, are prevented from reaching the compressor wheel.

One conceivable variant of the invention is such that the at least one bearing section has a hydrodynamic plain bearing, which is connected to a lubricant conduit in a fluid-conveying manner in such a way that lubricant can be supplied to the hydrodynamic plain bearing via a lubricant supply.

According to a variant of the invention, provision can be made for a bearing housing to be provided, in which the shaft is mounted by means of at least one bearing section, and that the motor housing is detachably connected to the bearing housing or is at least sectionally integrally connected to the bearing housing. If the motor housing is detachably connected to the bearing housing, individual system components can be formed, which in particular also permit a kit-like design. However, to reduce the assembly effort and number of parts, provision can also be made for the motor housing and the bearing housing to be integrally interconnected.

A particularly preferred variant of the invention is such that the gas pressure line passes at least sectionally through the bearing housing. The gas pressure line can therefore be integrated into the bearing housing without any additional assembly work being required. If the gas pressure line is integrated into the bearing housing, it is also protected against mechanical stresses.

However, it is also conceivable within the scope of the invention that a separate gas pressure line is installed.

In an alternative embodiment of the invention, provision can be made for instance, for the gas pressure line to be formed at least sectionally by a bypass line, preferably a flexible pipeline, which is preferably routed along the bearing housing.

A possible variant of the invention can be such that the mounting area of the motor housing has a pressure chamber, and that the at least one gas pressure line has a line outlet, which opens into the pressure chamber. An overpressure relative to the environment can then be reliably generated in the pressure chamber.

A gas compressor according to the invention can be designed in such a way that the mounting area of the motor housing is sealed off from the environment. In this way, pressure in the mounting area can be generated and maintained with optimized efficiency. To protect the electric motor, the built-up pressure can then only escape via unavoidable leakage points, for instance in the area of the sealing sections of the motor housing.

A particularly preferred variant of the invention is such that the compressor housing has a gas feed, that the compressor wheel is disposed downstream of the gas feed, that the compressor duct is disposed downstream of the compressor wheel, and that a line inlet of the gas pressure line opens in the area of the compressor duct. In this embodiment, the compressor section of the gas compressor, which is present anyway, is used as a gas pressure generator in the sense of the invention.

In particular, provision can also be made for the compressor duct to have a diffuser duct, to which a spiral duct is preferably connected downstream of the compressor wheel, and that the line inlet of the gas pressure line opens into the area of the diffuser duct or into the area of the spiral duct. This results in a particularly simple and compact design.

A further reduction of the constructional complexity can be achieved, for instance, in that the compressor housing is detachably connected to the bearing housing or in that the compressor housing is formed at least partially integrally by the bearing housing.

If provision is made for a cooling device to be provided, which has a coolant duct in such a way that the electric motor and/or the gas pressure line is/are cooled by means of a cooling medium routed in the coolant duct, then unintentional heating of the electric motor due to the action of compressed air can be prevented. It is, for instance, conceivable that a coolant duct, in which a coolant can circulate, is present in the bearing housing and/or the motor housing. The coolant duct can be used to cool the gas pressure line and/or the mounting area of the motor housing to dissipate heat.

Within the scope of the invention, provision can also be made in particular for the coolant duct to be routed in the area of the motor housing and/or in the area of the bearing housing. The coolant duct can, for instance, be incorporated into the motor housing and/or the bearing housing, for instance drilled into it, or it can be formed, for instance cast into it, during the manufacture of the motor housing and/or the bearing housing.

A gas compressor according to the invention can be such that the motor housing accommodates the motor stator including its stator core and stator windings, and that the motor stator is at least sectionally embedded in a casting compound in the motor housing. The casting compound can be used to securely hold the motor stator in the motor housing. In addition, the casting compound can be used to absorb heat from the mounting space into the casting compound and dissipate it through the casting compound. This improves the efficiency of the electric motor.

### BRIEF DESCRIPTION OF THE DRAWINGS

The invention is explained in greater detail below based on exemplary embodiments shown in the drawings. In the Figures:

FIG. 1 shows a full section and a partial representation of a gas compressor,

FIG. 2 shows a perspective view of the motor unit of the gas compressor of FIG. 1,

FIG. 3 shows a side view and a sectional view of the motor unit of FIG. 2,

FIG. 4 shows a motor unit having a modified motor housing,

FIG. 5 shows a side view and a sectional view of the motor unit of FIGS. 2 and 3 as a simplified representation and

FIG. 6 shows a side view and a full section of a further design variant of a gas compressor.

### DETAILED DESCRIPTION

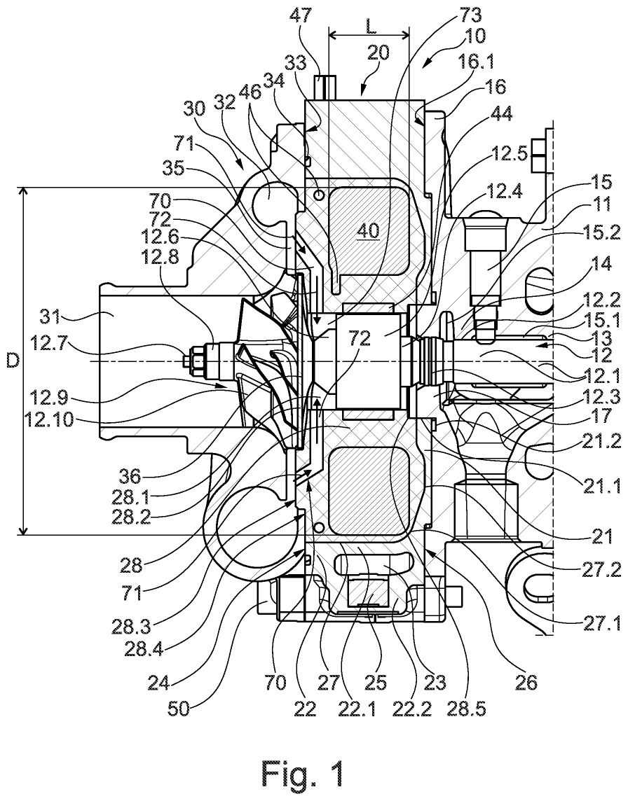

FIG. 1 shows a gas compressor 10, for instance a turbocharger, in particular an exhaust gas turbocharger, for use in an internal combustion engine. However, the invention is not limited to exhaust gas turbochargers, but can also be used in any other gas compressor, for instance in a turbocharger, for instance in fuel cell arrangements for gas compression or in any other air supercharging units.

For the sake of clarity only part of the turbocharger is shown in FIG. 1. In particular, this representation illustrates the design of the turbocharger in the area of its compressor. On the right-hand side of the illustration, a dashed line indicates that the turbocharger can also have an expansion side having a turbine wheel. This area of the turbocharger can be designed in a typical manner. Preferably, this area can then also be designed as described in EP 3 293 406 A1.

The turbocharger has a bearing housing 11, in which a shaft 12 is rotatably mounted. Preferably, the bearing of the shaft 12 is designed as described in EP 3 293 406 A1. Accordingly, within the scope of the invention, at least one, preferably two hydrodynamic plain bearings 12.2 may be used to support the shaft 12.

However, it is also conceivable within the scope of the invention that the shaft 12 is supported by means of one or more rolling element bearings, for instance ball bearings.

Finally, it is also conceivable within the scope of the invention that the shaft 12 is supported in a mixed manner by means of one or more hydrodynamic plain bearings 12.2 and one or more rolling element bearings.

The hydrodynamic plain bearing 12.2 has a stator and a rotor rotatable relative to the stator, wherein a rotor bearing surface faces a mating surface of the stator for hydrodynamic pressure generation. The rotor bearing surface and/or the mating surface, when cut along and through the axis of rotation of the shaft 12 in sectional view, form a continuous bearing contour formed by at least two contour sections.

The contour trace formed by the contour sections is designed in such a way that it generates hydrodynamic load-bearing capacity, preferably continuous in the axial direction of the shaft 12, which acts in the radial and axial directions. In this case, for instance, the contour sections can be continuously merged into one another by means of at least one transition section in such a way that the contour sections and the transition section generate a continuous hydrodynamic load-bearing capacity.

The plain bearing is preferably designed as a multi-surface plain bearing having two or more lubricating wedges in the area of the contour sections and the transition section.

In accordance with the above, the shaft 12 may have, for instance, two bearing sections 12.1, each of which is part of a hydrodynamic plain bearing 12.2. The two hydrodynamic plain bearings 12.2 are axially spaced apart. One of the hydrodynamic plain bearings 12.2 can be disposed in the area of the compressor side of the turbocharger, as shown in FIG. 1. The other hydrodynamic plain bearing 12.2 can be assigned to the turbine-side area of the turbocharger. The two bearing sections 12.1 face bearing locations 13, 14 of the bearing housing 11 to form the hydrodynamic plain bearings 12.2. In this case, the bearing points 13, 14 can also be formed by a separate bushing or separate bushings of the bearing housing 11. The hydrodynamic plain bearings 12.2 are supplied with lubricant via a lubricant supply 15 of the bearing housing 11. The lubricant supply 15 has lubricant conduits 15.1, which are routed to the hydrodynamic plain bearings 12.2. Furthermore, discharges 15.2 are provided. The lubricant can be drained through these after flowing through the hydrodynamic plain bearings 12.2.

The shaft 12 has a sealing section 12.3 downstream of the bearing section 12.1. This sealing section 12.3 seals the shaft 12 against a feed-through of the bearing housing 11. The sealing section 12.3 can be made from the shaft 12 itself, i.e. be integral therewith. However, it is also conceivable that the shaft 12 bears a separate component forming the sealing section 12.3. Preferably, provision can be made for this separate component to also form the bearing section 12.1, wherein further preferably the bearing section 12.1 is integrally connected to the sealing section 12.3.

The shaft 12 bears a motor rotor 12.4 indirectly or directly adjacent to the sealing section 12.3. The motor rotor 12.4 is part of an electric motor and has permanent magnets 12.5 secured to the shaft 12.

The shaft 12 forms a transition section 12.6 on the side of the motor rotor 12.4 opposite from the sealing section 12.3. A compressor wheel 12.9 is mounted on this transition section 12.6. For this purpose, the compressor wheel 12.9 has a drilled hole, which is used to push the compressor wheel onto the shaft 12. The compressor wheel 12.9 rests against the transition section 12.6 and is secured using a nut 12.8. The nut 12.8 is screwed onto an end section 12.7 of the shaft 12.

The compressor wheel 12.9 has an end element 36, on which compressor blades 12.10 are integrally formed. The compressor wheel 12.9 is rotatably disposed in a compressor housing 30. The compressor housing 30 has a gas feed 31 disposed upstream of the compressor wheel 12.9. A diffuser duct 35 is provided downstream of the compressor wheel 12.9. The diffuser duct 35 merges into a spiral compressor duct 32. The diffuser duct 35 and the spiral compressor duct 32 together may be referred to as a compressor duct or as a gas routing area for routing or conducting a gas stream compressed by the compressor wheel 12.9.

As FIG. 1 shows, the compressor housing 30 has a connection end 33. This connection end 33 is used to couple the compressor housing 30 to a motor housing 20. To this end, the connection end 33 of the compressor housing 30 rests on a support surface 24 of the motor housing 20. For a sealed connection, a seal 34 is provided in the area of the connection end 33.

The motor housing 20 is preferably made of a non-magnetizable material, for instance aluminum, and has a shell 21 disposed on the end facing the bearing housing 11 in the form of a bottom. The shell 21 is provided with a feed-through 21.1 in the form of a drilled hole. A centering section 17 of the bearing housing 11 is fitted into this feed-through 21.1. In this way, the motor housing 20 is aligned in the radial direction with respect to the bearing housing 11. Advantageously, provision can further be made for the feed-through 21.1 to have a further axial section in addition to the centering shoulder 17. This further axial section has an inner diameter that differs from that of the centering shoulder 17 and is used to mount the motor rotor 12.5.

As FIG. 1 shows, motor housing 20 is disposed between the bearing housing 11 and the compressor housing 30. Accordingly, the bearing housing 11 has a mounting surface 16.1, which can preferably be formed at a flange 16. A support surface 26 of the motor housing 20 rests against the mounting surface 16.1. A seal 21.2 is provided for sealing in the area between the support surface 26 and the mounting surface 16.1.

A compact and easy-to-mount design is achieved by placing the motor housing 20 between the bearing housing 11 and the compressor housing 30. Fastening elements 50, for instance fastening screws, can be provided for securing the structural units to one another. The fastening elements 50 can be used to brace the three housings against one another.

The motor housing 20 has a circumferential side wall 22 adjacent to the shell 21. In the process, the side wall 22 ascends from the shell 21. In this exemplary embodiment, the side wall 22 connects indirectly to the shell 21 via a rounding 27.1. Accordingly, the side wall 22 forms an inner wall 22.1. It transitions into a bottom section 27.2 of the shell 21 via the rounding 27.1.

The inner wall 22.1, the rounding 27.1 and the bottom section 27.2 form a joint mount. A casting compound 28 is held in this mount.

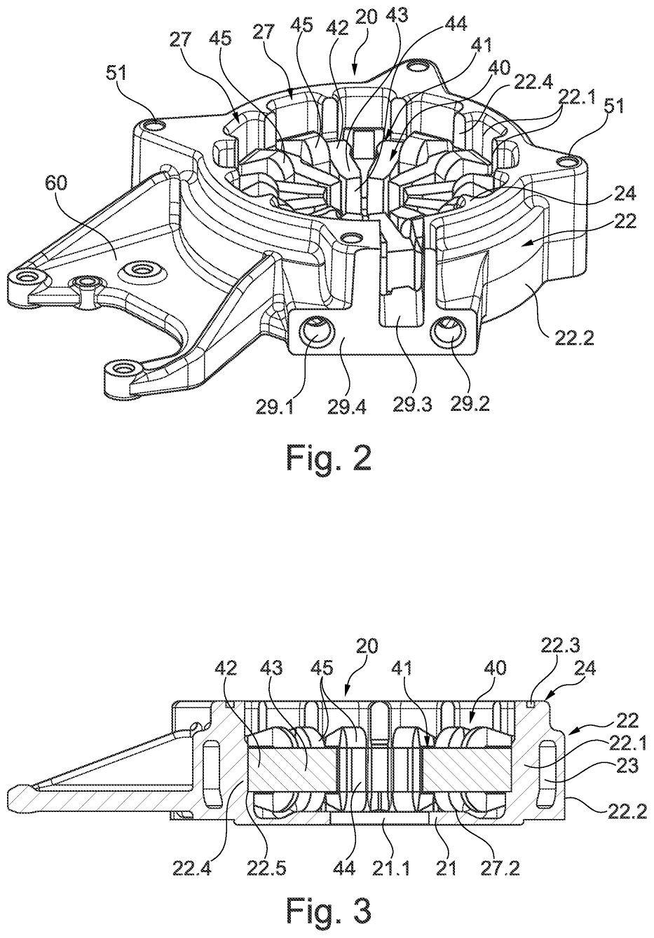

FIGS. 2 and 3 show the design of the motor housing 20 in more detail. As these illustrations show, the inner wall 22.1 is provided with support sections 22.4 spaced apart from one another in the circumferential direction. Mounting areas 27 are formed between the support sections 22.4. These mounting areas 27 are incorporated into the inner wall 22.1 in the form of recessed troughs.

A motor stator 40 may be held within the motor housing 20. The motor stator 40 has a stator core 41 made of ferromagnetic material. In particular, the stator core 41 is formed of a plurality of electrical sheets stacked on top of each other in the axial direction of the shaft 12. For instance, the stator core 41 may be stamp-stacked. In this process, individual stator laminations are punched out of a sheet blank and stacked on top of each other. The individual stator laminations may be interconnected by embossments to form a homogeneous stator core 41.

As FIG. 2 shows, the core of the stator 41 has teeth 43. These teeth 43 project radially inwards. Connecting sections 42 are used to interconnect the teeth 43 at their radially outer areas. Preferably, the connecting sections 42 are integrally connected to the teeth 43. The teeth 43 have pole pieces 44 at their radially inner ends.

The stator core 41 has coils 45. These coils 45 are formed by electrically conductive wires wound around the connecting sections 42. As FIG. 2 shows, mounts 27 are used to hold the radially outer areas of the coils 45. The radially inner area of each of the coils 45 is located between two adjacent teeth 43.

As FIG. 3 shows, the stator core 41 and its coils 45 can be inserted into the motor housing 20. The stator core 41 is supported radially on the outside by its connecting sections 42 on the support sections 22.4 of the motor housing 20. The support sections 22.4 distributed around the circumference of the stator core 41 achieve a radial centering of the stator core 41. Ideally, the stator core 41 is in direct contact with the support sections 22.4 to achieve good thermal conduction of the heat loss generated in the electric motor into the motor housing 20. However, a small amount of play may also be provided here for manufacturing reasons. However, this play should be such that any resulting misalignment of the motor stator 40 to the motor rotor 12.4 does not adversely affect the rotor dynamics.

Alternatively, the stator core 41 may have teeth 43 pointing radially outwards directed in extension of the teeth pointing inwards such that the stator core 41 contacts the support sections 22.4 via the teeth directed radially outwards.

Additionally or alternatively, the stator core 41 may be supported on abutments 22.5 of the motor housing 20 in the axial direction of the shaft 12. The abutments 22.5 can, for instance, adjoin the support sections 22.4 at an angle. The abutments 22.5 establish a defined spacing between the motor stator 40 and the bearing housing 11 adjoining the motor housing 20. Preferably, this spacing should not be smaller than 2 mm. This minimum distance is particularly necessary if the bearing housing 11 is made of a magnetizable material.

The radially inner pole pieces 44 are located on an inner circle, as shown in FIGS. 2 and 3. This inner circle is disposed concentrically to the feed through 21.1 in the shell 21.

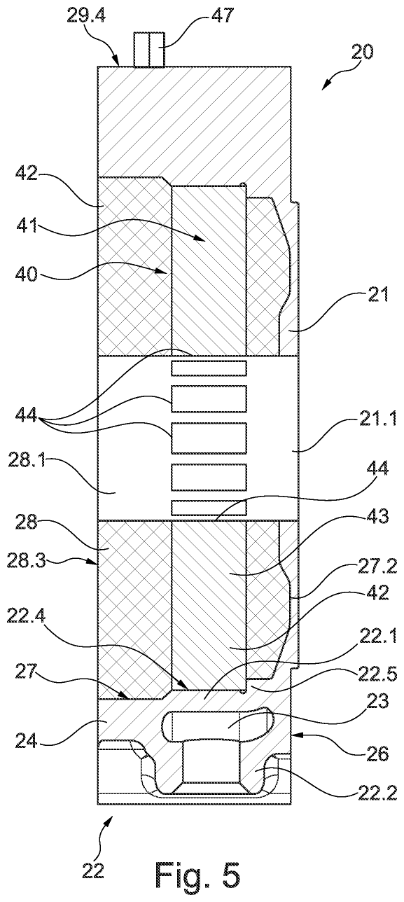

The stator core 41, which is inserted into the motor housing 20, can be enclosed by the casting compound 28, as shown in FIGS. 1 and 5. In the area of the coils 45, the teeth 43 and the connecting sections 42 the cast-in stator core 41 is enclosed by the casting compound 28. Only the free ends of the teeth 43 forming the pole pieces 44 and/or the areas facing the support sections 22.4 and/or the abutments 22.5 are not enclosed by the casting compound 28. However, it is also conceivable that gap areas are formed between the support sections 22.4 and/or the abutments 22.5, in which casting compound 28 is also disposed.

FIGS. 1 and 5 further show that the pole pieces 44 face the motor rotor 12.4 while maintaining a gap area. The casting compound 28 forms an aperture 28.1 that is coaxial to the circle enclosed by the pole pieces 44. Preferably, the diameter of this aperture 28.1, which is formed as a drilled hole, matches the diameter of the circle enclosed by the pole pieces 44. Then the aperture 28.1 and the radially inner ends of the pole pieces 44 can be machined in one clamping operation. For instance, a drill can be used to machine the aperture 28.1 and the pole pieces 44 simultaneously.

FIG. 1 shows that the casting compound 28 has a boundary surface 28.2 behind the compressor wheel 12.9. The limiting surface 28.2 is disposed at a distance from the rear side of the end element 36 of the compressor wheel 12.9 while maintaining a gap. The casting compound 28 can be machined to fit precisely to create the boundary surface and adapted to the contour of the compressor wheel 12.9. As further shown in FIG. 1, the boundary surface 28.2 can merge into an air routing element 28.3 via a shoulder. The air routing element 28.3 preferably extends in the radial direction.

The shoulder between the boundary surface 28.2 and the air routing element 28.3 may, for instance, be such that it overlaps the radially outer area of the end element 36. In this way, improved air routing is achieved in particular when the air routing element 28.3 is directly adjacent to the air routing areas formed by the compressor blades 12.10, preferably without a shoulder.

The air routing element 28.3 can form a boundary surface for the diffuser duct 35, as shown in the exemplary embodiment of FIG. 1. Accordingly, the diffuser duct 35 is formed between the air routing element 28.3 and a wall area of the compressor housing 30.

The air routing element 28.3 does not have to (completely) extend radially. It can also have any other contour to provide suitable airflow in an optimal manner.

The figures further show that the compressor duct 32 in the form of a spiral duct adjoins the diffuser duct 35 downstream. The air routing element 28.3 can in particular be guided into the area of the compressor duct 32 and/or be part thereof. However, it is also conceivable that the air routing element 28.3 only limits the diffuser duct 35 along its entire radial extent or only along part of its radial extent.

The fact that the air routing element 28.3 limits the diffuser duct 35 results in a compact design of the turbocharger in the axial direction. In particular, the compressor wheel 12.9 can be disposed close to the facing bearing point 14. This reduces the bearing load and increases the smooth running of the turbocharger.

In another advantageous embodiment, the end of the casting compound 28 facing the compressor housing 30 may be machined to form a shoulder 28.4. This shoulder 28.4 engages with a recess in the compressor housing 30 to exactly align it radially with respect to the motor housing 20.

FIG. 1 further shows that in the area of the shell 21 and coaxially with the feed through 21.1 the casting compound 28 may be provided with a clearance 28.5. In this way, the casting compound 28 does not obstruct the positioning of the centering shoulder 17.

The coils 45 may be connected to a power supply via power supply leads 46. The power supply leads 46 are preferably embedded in the casting compound 28. As FIG. 1 shows, a space area can be provided for this purpose between the stator core 41 and the compressor wheel 12.9 in the motor housing 20, for instance, in which the power supply lines 46 are installed and which is filled with the casting compound 28. In this way, the power supply lines 46 are housed protected from corrosion and mechanical stresses.

FIG. 2 shows that the motor housing 20 has an opening 29.3 in the end that provides access to the area where the motor stator 40 is held in the motor housing 20. This opening 29.3 is used to route the power supply lines 46 laterally out of the spatial area formed by the motor housing 20. Accordingly, the power supply lines 46 can be routed to a connection end 29.4 of the motor housing 20. Preferably, the casting compound 28 fills the duct area forming the opening 29.3. In FIG. 1, it is indicated that a power connection 47, for instance a plug element, can be disposed in the area of the connection end 29.4. This power connection 47 can be used to easily couple the coils 45 to a power supply. The power connection may be molded into the casting compound 28.

The drawings further show that the motor housing 20 includes a cooling section 22.2. This cooling section 22.2 can, for instance, encompass the motor stator 12.4 radially on the outside. A coolant duct 23 is incorporated in to the cooling section 22.2. This coolant duct 23 extends around the motor stator 12.4 along at least 180°, preferably along at least 270° of its circumference. The ends of the coolant duct 23 open into a coolant outlet 29.1 and into a coolant inlet 29.2. The coolant outlet 29.1 and the coolant inlet 29.2 can be prepared to position connection nozzles therein, which can be used to connect a hose or similar coolant line. As FIG. 2 shows, the coolant outlet 29.1 and the coolant inlet 29.2 are formed side by side on the same side of the motor housing 20. In this way, a cooling jacket is created in the motor housing 20, which can flow almost completely around the motor housing 20 in the circumferential direction of the motor housing 20.

Ideally, the power supply wires 46 are routed between the coolant outlet 29.1 and the coolant inlet 29.2 through the opening 29.3 preventing any collisions of the wiring and the coolant routing.

Further ideally, the motor housing is made of a material of good thermal conductivity, for instance aluminum. The use of a suitable plastic is also conceivable. Owing to the compact design of the motor housing 20, the material should not be magnetizable as to not impair the functionality of the electric motor.

If the motor housing 20 is made as a cast part, then a lost core is used to manufacture the coolant duct 23. One or more radial accesses to the coolant duct 23 are created for its manufacture. These radial accesses can be used to remove the lost core once the motor housing 20 has been manufactured. The radial accesses can then be sealed in a fluid-tight manner using a plug 25, for instance.

As FIG. 1 illustrates, the motor housing 20 has a gas pressure line 70. It may be incorporated into the casting compound 28 of the motor housing 20. Within the scope of the invention, the gas pressure line 70 may also extend at least sectionally in the area of the side wall 22 of the motor housing 20 or any other motor housing area. The gas pressure line 70 may also be referred to as a gas pressure passage 70.

The gas pressure line 70 has a line inlet 71 and a line outlet 72. The line inlet 71 opens into the pressure area of the compressor housing 30, i.e. downstream of the compressor wheel 12.9.

In this exemplary embodiment, the line inlet 71 opens into the area of the diffuser duct 35. However, the line inlet may also open at any other point in the pressure area of the compressor housing, for instance into the spiral duct.

Furthermore, it is conceivable that the conduit inlet 71 opens into a conduit area downstream of the spiral duct.

The line outlet 72 opens into the mounting space of the motor housing 20 forming a pressure chamber 73.

During operation, the compressor wheel 12.9 generates a gas flow, wherein gas, in particular air, is supplied via the gas supply 31 and compressed by means of the compressor wheel 12.9. The compressed gas is routed to the adjacent spiral duct via the diffuser duct 35. The compressed gas is then discharged from the compressor housing 30.

The compressed gas is fed into the pressure chamber 73 via the gas pressure line 70, resulting in approximately the same pressure being present here as in the pressure area, for instance in the diffuser duct 35 or in the spiral duct. If then no complete sealing effect is achieved in the area of the sealing section 12.3 during an operating state of the gas compressor, the gas pressure present in the pressure chamber 73 prevents lubricant from passing beyond the sealing section 12.3 into the motor housing 20, in particular the mounting area of the motor housing 20.

In the context of the invention, it may in particular happen that the pressure level in the pressure chamber 73 is greater than the pressure in the area of the bearing housing 11, in which the bearing section 12.1 facing the sealing section 12.3 is disposed in the bearing housing 11. Thus, the lubricant is reliably retained in the bearing housing 11 and is prevented from entering the motor housing 20.

Because both the electric motor and the compressor wheel 12.9 are located on the side of the seal 12.3 facing away from the bearing section 12.1 (in the axial direction of the shaft 12) not only is contamination of the mounting space of the motor housing 20 prevented, but also additionally contamination in the area of the compressor housing 30. In particular, it prevents contamination of the gas stream compressed by the compressor wheel 12.9.

The turbocharger is assembled as follows. First, the bearing housing 11 with the shaft 12 mounted therein is prepared. Then the motor housing 20 is pushed onto the shaft 12 until the motor rotor 12.4 faces the motor stator 40, forming a gap area. The mounting surface 16.1 against which the motor housing 20 abuts limits this joining movement. The compressor wheel 12.9 can then be mounted on the shaft 12 and the nut 12.8 can be tightened.

Finally, the compressor housing 30 is attached to the motor housing 20 on the side opposite from the bearing housing 11. The compressor housing 30, the motor housing 20 and the bearing housing 11 have interaligned drilled holes. Fastening bolts 50 can be inserted into these holes and bolted there. Alternatively, the motor housing 20 may be bolted to the bearing housing 11. The compressor housing 30 can also be connected only to the motor housing 20, for instance by a separate screw or bolt connection or by a fastener strap.

To manufacture the motor housing 20, first the structural unit shown in FIGS. 2 and 3 is formed. In this case, the shell 21 is designed in such a way that it is not yet provided with the feed-through 21.1. Subsequently, the structural unit formed in FIGS. 2 and 3 can be filled with the casting compound 28. Then, in a single step, the aperture 28.1 is drilled in the casting compound 28 and at the same time the feed through 21.1 is drilled. Furthermore, the air routing element 28.3 and/or the boundary surface 28.2 and/or the shoulder 28.4 and/or the clearance 28.5 can be reworked on the cured casting compound 28 using machining.

For instance, the casting compound 28 may be formed of a thermally resistant material, preferably a resin material, such as a high temperature resin filled with materials.

Preferably, the casting compound is formed from a thermally conductive material and preferably has a thermal conductivity in the range from 0.5 W/(m K) and 5 W/(m K). In this way, the heat loss of the electric motor can be reliably dissipated into the cooling medium in the coolant duct 23 via the contact areas between the casting compound 28 and the motor housing 20. In this way, heat is also dissipated via the air routing element 28.3 into the compressor air, which is routed in the compressor housing 30.

To prevent a short circuit, the casting compound 28 is preferably made of an electrically non-conductive material. Then additional insulation measures can be dispensed with.

As FIG. 2 shows, a bracket 60, for mounting an actuator of the electrically assisted turbocharger, may be molded to the motor housing 20.

In the exemplary embodiment shown in FIGS. 1 to 5, the stator core 41 is supported against the inner wall 22.1 at the support sections 22.4 projecting axially inwards. Alternatively, however, it is also conceivable that radially outwards projecting support sections are present on the stator core 41, which support sections are then in contact with the motor housing 20.

To prevent rotation of the stator core 41 relative to the motor housing 20, it is advisable to provide a circumferential positive connection between the motor housing 20 and the stator core 41.

Additionally or alternatively, the casting compound 28 can be used to prevent the stator core 41 from rotating relative to the motor housing 20 by bonding.

Furthermore, for instance, a material bond and/or a form-fit connection can also be established between the stator core 41 and the motor housing 20.

Another alternative embodiment provides that the motor unit has an annular motor housing 20 closed off by the electrically insulating casting compound 28 on both the compressor side and the bearing housing side. The motor housing 20 is thus bottomless and not cup-shaped.

Another alternative embodiment may be such that the motor housing 20 and the bearing housing 11 are manufactured integrally, for instance of aluminum or plastic.

During operation of the turbocharger, the electric motor can support the drive of the compressor wheel 12.9. In so doing, heat losses are generated in the coils 45 of the motor stator 40. This heat loss is transferred to the stator core 41. Because the stator core is now in contact with the motor housing 20 via the support sections 22.4, this heat is at least partially introduced into the motor housing 20. The motor housing 20 is made of a material having good thermal conductivity, for instance aluminum, as mentioned above. Accordingly, the heat is routed into the coolant duct and the fluid flowing there. If, as in this exemplary embodiment, provision is also made for the stator core 41 to be supported on the abutments 22.5, heat is also introduced into the motor housing 20 via the abutments 22.5.

For the purpose of particularly effective heat dissipation, provision can be made for a support section 22.4 and/or an abutment 22.5 to be assigned to each connecting section 42 of the stator core 41. This can maximize the thermally effective contact area between the stator core 51 and the cooled housing 20. In this exemplary embodiment, six pairs of poles of the electric motor are provided. Accordingly, twelve support sections 22.4 and/or twelve abutments 22.5 are provided. However, this is not mandatory. In particular, only part of the support sections 22.4 and/or part of the abutments 22.5 can be in contact with the stator core 41.

The drawings also show that the support sections 22.4 are in radial extension of the teeth 43 of the stator core. It is particularly advantageous if the interconnecting cooling sections of the motor housing 20 and the interconnecting sections 42 of the stator core 41 are disposed centrally or approximately centrally between the adjacent coils 45 to achieve uniform heat dissipation.

As shown in particular in FIG. 2, the coolant duct 23 extends from the coolant inlet 29.2 to the coolant outlet 29.1. The drawing indicates that in this case the coolant duct 23 extends around more than 270° of the circumference of the motor stator 40, rendering a particularly effective cooling possible.

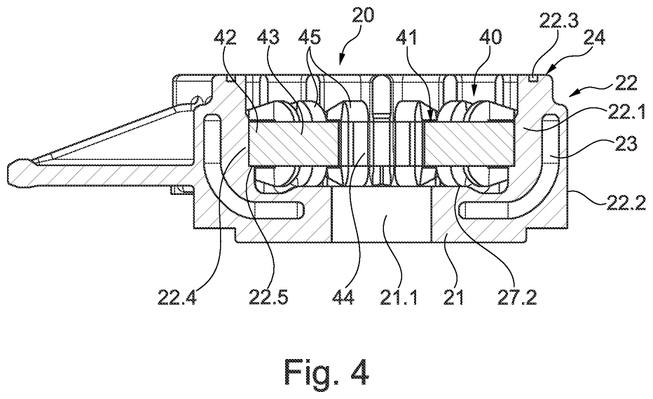

FIG. 4 shows a motor unit that is essentially the same as the motor unit shown in FIGS. 1 to 3 and 5. In this respect, reference is made to the above explanations of these figures. To avoid repetition, only the differences are discussed below. As FIG. 4 shows, the motor housing 20 is modified with respect to the design of the coolant duct 23. Accordingly, the coolant duct 23 has a first area extending in the axial direction of the shaft. Adjacent to this first area, the coolant duct 23 has a radial area extending at least sectionally in the radial direction. The projections of the motor stator 40 and the radial area in the direction of the axis of the shaft 12 in one plane overlap at least sectionally. In this embodiment of a gas compressor/turbocharger 10, heat is dissipated not only from the coils 45 into the coolant duct 23 in the radial direction, but also in the axial direction of the shaft 12.

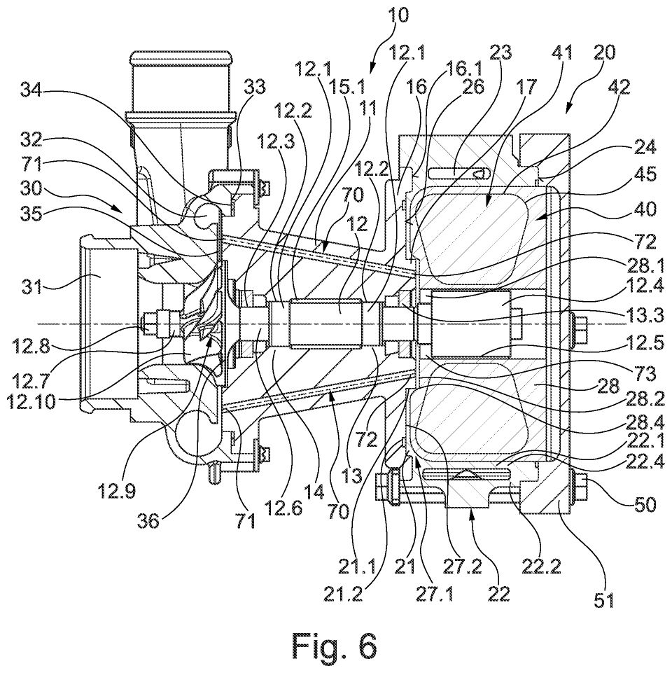

FIG. 6 shows a further exemplary embodiment of the invention, wherein an electrically driven compressor is shown as the gas compressor 10, which can be used in particular as a compressor for a fuel cell.

Identical components or components having the same effect are provided with the same reference signs, which is why reference can be made to the above explanations to avoid repetitions.

As FIG. 6 shows, again a bearing housing 11 is used, in which a shaft 12 is supported on two bearing sections 12.1. At least one of the bearing sections 12.1 may have a hydrodynamic plain bearing 12.2.

The compressor housing 30 including its gas feed 31 and compressor duct 32 are located on the left side of the bearing housing 11 in FIG. 6.

The compressor housing 30 may be interchangeably connected to the bearing housing 11. For this purpose, the connection end 33 and using a seal 34 of the compressor housing 30 is connected, for instance screwed or bolted, to the bearing housing 11.

On the opposite side of the bearing housing 11, the motor housing 20 is connected to the bearing housing 11. Similar to the first exemplary embodiment, the motor housing 20 has a shell 21, in which an annular coolant duct 23 is disposed. The motor housing 20 encompasses a mounting space, in which the motor rotor 12.4 and the motor stator 40 are disposed.

The motor housing 20 has a support surface 24 opposite from the bearing housing 11. Fastening elements 50 are used to connect the cover 51 placed on this support surface 24 in a sealed manner to the motor housing 20. In this way, a sealed enclosure of the mounting space is achieved.

As FIG. 6 further shows, a gas pressure line 70 is provided, as in the exemplary embodiment according to FIGS. 1 to 5, a line inlet 71 of which opens in the pressure range of the pressure generator, i.e. downstream of the compressor wheel 12.9. In this exemplary embodiment, the line inlet 71 opens into the diffuser duct 35. However, as described above, it can also open out at any other point downstream of compressor wheel 12.9. The gas pressure lines 70 are integrated into the bearing housing 11, for instance as drilled holes.

The gas pressure lines 70 each have a line outlet 72, which in turn opens into the mounting area of the motor housing 20 and consequently this line outlet 22 is connected to a pressure chamber 73 in a gas-conveying manner.

During operation, compressed gas can enter the area of the pressure chamber 73 via the gas pressure lines 70, such that a pressure level can be generated, which prevents contaminants, for instance lubricants from the bearing housing 11, from entering the mounting space of the motor housing 20.

1-15. (canceled)

16: A gas compressor, comprising:
a rotatably mounted compressor wheel;
a compressor housing, the compressor wheel being at least partially received in the compressor housing, the compressor housing including a compressor duct configured to conduct a gas stream compressed by the compressor wheel;
a motor housing;
an electric motor mounted at least partially in a mounting area of the motor housing, the electric motor including a motor rotor and a motor stator, the motor rotor being configured for rotation with the compressor wheel;
a gas pressure generator; and
at least one gas pressure line configured to convey gas from the gas pressure generator to the mounting area of the motor housing.

17: The gas compressor of claim 16, wherein:
the gas pressure generator includes the compressor wheel; and
the at least one gas pressure line is communicated directly or indirectly with the compressor duct of the compressor housing.

18: The gas compressor of claim 16, further comprising:
a bearing housing;
a shaft including at least one bearing section and a sealing section, the at least one bearing section rotatably mounting the shaft in the bearing housing, the sealing section being arranged in an axial direction of the shaft between the bearing section and the motor rotor, the motor rotor being coupled directly or indirectly to the shaft; and
wherein the mounting area of the motor housing is disposed in the axial direction of the shaft on an opposite side of the sealing section from the at least one bearing section.

19: The gas compressor of claim 18, wherein:
the compressor wheel is disposed in the axial direction of the shaft on the opposite side of the sealing section from the at least one bearing section.

20: The gas compressor of claim 18, wherein:
the at least one bearing section includes a hydrodynamic plain bearing; and
the gas compressor further includes a lubricant supply and a lubricant conduit configured to supply lubricant from the lubricant supply to the hydrodynamic plain bearing.

21: The gas compressor of claim 18, wherein:
the motor housing is detachably connected to the bearing housing or at least partially connected integrally to the bearing housing.

22: The gas compressor of claim 18, wherein:
the at least one gas pressure line passes at least partially through the bearing housing.

23: The gas compressor of claim 18, wherein:
the at least one gas pressure line is formed at least in part by a flexible bypass line.

24: The gas compressor of claim 16, wherein:
the motor housing includes a pressure chamber; and
the at least one gas pressure line includes a line outlet open to the pressure chamber.

25: The gas compressor of claim 16, wherein:
the mounting area of the motor housing is sealed from an environment external of the motor housing.

26: The gas compressor of claim 16, wherein:
the compressor housing includes a gas feed and the compressor duct, the compressor wheel being located downstream of the gas feed, the compressor duct being located downstream of the compressor wheel; and
the at least one gas pressure line includes a line inlet open to the compressor duct.

27: The gas compressor of claim 26, wherein:
the compressor duct includes a diffuser duct and a spiral duct, the spiral duct being located downstream of the diffuser duct; and
the line inlet is open to either the diffuser duct or the spiral duct.

28: The gas compressor of claim 16, further comprising:
a bearing housing;
a shaft including at least one bearing section and a sealing section, the at least one bearing section rotatably mounting the shaft in the bearing housing, the sealing section being arranged in an axial direction of the shaft between the bearing section and the motor rotor, the motor rotor being coupled directly or indirectly to the shaft; and
wherein the compressor housing is either detachably connected to the bearing housing or formed at least partially integrally by the bearing housing.

29: The gas compressor of claim 16, further comprising:
a coolant duct configured to carry a coolant medium to cool the electric motor.

30: The gas compressor of claim 29, wherein:
the coolant duct is at least partially formed in the motor housing.

31: The gas compressor of claim 16, wherein:
the motor stator includes a stator core and a plurality of stator windings;
the motor housing includes a casting compound; and
the motor stator is at least partially embedded in the casting compound of the motor housing.

32: The gas compressor of claim 16, further comprising:
a controllable valve configured to control a flow of gas through the at least one gas pressure line.

33: A gas compressor, comprising:
a rotatably mounted compressor wheel;
a compressor housing, the compressor wheel being at least partially received in the compressor housing, the compressor housing including a compressor duct configured to conduct a gas stream compressed by the compressor wheel;
a motor housing;
an electric motor mounted at least partially in a mounting area of the motor housing, the electric motor including a motor rotor and a motor stator, the motor rotor being configured for rotation with the compressor wheel; and
a gas pressure passage configured to convey pressurized gas from the compressor duct of the compressor housing to the mounting area of the motor housing.

34: The gas compressor of claim 33, further comprising:
a bearing housing;
a shaft including at least one bearing section and a sealing section, the at least one bearing section rotatably mounting the shaft in the bearing housing, the sealing section being arranged in an axial direction of the shaft between the bearing section and the motor rotor, the motor rotor being coupled directly or indirectly to the shaft;
a lubricant conduit configured to supply lubricant to the at least one bearing section; and
wherein the mounting area of the motor housing is disposed in the axial direction of the shaft on an opposite side of the sealing section from the bearing section such that the pressurized gas in the mounting area of the motor housing reduces any leakage of lubricant from the at least one bearing section past the sealing section into the mounting area of the motor housing.

35: The gas compressor of claim 34, wherein:
the motor housing is located between the compressor housing and the bearing housing.
